(19) United States
(12) Patent Application Publication
(10) Pub. No.: US 2025/0278397 A1
(43) Pub. Date: Sep. 4, 2025

(54) METHODS AND SYSTEMS FOR OPERATING LARGE LANGUAGE MODELS USING SINGLE-INSTRUCTION-MULTIPLE-DATA REGISTERS

(71) Applicant: William Marsh Rice University, Houston, TX (US)

(72) Inventors: Tianyi Zhang, Houston, TX (US); Jonah Wonkyu Yi, Houston, TX (US); Anshumali Shrivastava, Houston, TX (US)

(73) Assignee: William Marsh Rice University, Houston, TX (US)

(21) Appl. No.: 19/067,354

(22) Filed: Feb. 28, 2025

Related U.S. Application Data
(60) Provisional application No. 63/559,714, filed on Feb. 29, 2024.

(51) Int. Cl. G06F 16/23; G06F 9/38; G06F 16/2455

(52) U.S. Cl. CPC G06F 16/2365; G06F 9/3887; G06F 16/24553

(57) ABSTRACT

A method includes obtaining a plurality of query vectors, key vectors, and value vectors based on an input sequence of text. The method also includes obtaining a plurality of quantized key vectors by applying product quantization to the plurality of key vectors, and for each query vector, compressing a lookup table into at least one single instruction multiple data (SIMD) register of a plurality of SIMD registers in a CPU to produce a compressed lookup table, and performing a parallel processing operation using a plurality of SIMD instructions and the lookup table in the SIMD register to determine a plurality of attention scores. The method further includes generating a predicted sequence of text based on the plurality of attention scores, where the predicted sequence of text is determined using the plurality of attention scores by accessing the compressed lookup tables in the at least one SIMD register.

### CROSS-REFERENCE TO RELATED APPLICATIONS

This application claims priority to U.S. Provisional Patent Application No. 63/559,714 filed on Feb. 29, 2024, the contents of which are hereby incorporated herein by reference in their entirety.

### BACKGROUND

Large language models (LLMs) are a popular type of machine learning model due to their utility in performing many complex tasks involving natural language processing. LLMs typically require expensive computing resources, such as graphics processing units (GPUs), designed specifically for executing many computational tasks in parallel. However, the most ubiquitous computer processing unit by far is the standard central processing unit (CPU), which virtually every modern computer, from desktops to smart phones, is equipped with. Historically, it has not been possible to leverage CPUs to perform the computational tasks required by LLMs on practical time scales. Consequently, the requirement of more expensive hardware has limited access to LLMs, and there exists a need for methods and systems capable of utilizing CPUs to efficiently and reliably perform the computational tasks required by LLMs.

Since the introduction of attention in transformers, a popular architecture used in many modern LLMs, there has been a body of work on approximating the attention mechanism for efficient training and inference of transformers. For example, dynamically sparse attention has been achieved using locality sensitive hashing (LSH), the Nyström method, and random sampling. Furthermore, low-rank attention has been extensively explored and shown to have compute- and memory-efficiency advantages over regular transformers. Attention mechanisms with hardware-aware designs such as FlashAttention have been proposed to mitigate the IO bottleneck in GPUs. In large language models, multiple approaches have been proposed to reduce the high memory overhead of the KV cache. For CPU-only environments, others have proposed to speed up LLM inference through weight quantization.

Approximate matrix multiplication is applicable in a wide range of computational problems from statistical analysis to image compression, and its optimization has been a topic of interest for years. Using novel compression techniques and specialized hardware, modern researchers have begun optimizing matrix multiplication around the specific limitations of computers including their memory capacity and traffic between the CPU and main memory. Compression techniques were developed to multiply billion-scale matrices, fully utilize the DSP, and use learning-based algorithms on computers. However, many of these algorithms still had limitations ranging from training on a matrix to megabytes of hardware resources and computation that made the matrix multiplication of LLMs nearly impossible to compute without prior training or significant hardware resources.

### SUMMARY

This summary is provided to introduce a selection of the concepts that are further described below in the detailed description. This summary is not intended to identify key or essential features of the claimed subject matter, nor is it intended to be used as an aid in limiting the scope of the claimed subject matter.

Embodiments disclosed herein generally relate to a method. The method includes obtaining, by a large language model in a computer, an input sequence of text including a plurality of elements of text, converting, by the computer, each element in the plurality of elements of text into a token, resulting in a plurality of tokens, and transforming, by the computer, each token in the plurality of tokens into a query vector, key vector, and value vector, resulting in a plurality of query vectors, key vectors, and value vectors. The method also includes obtaining, by the computer, a plurality of quantized key vectors by applying product quantization to the plurality of key vectors, and for each query vector, compressing, by the computer, a lookup table into at least one single instruction multiple data (SIMD) register of a plurality of SIMD registers in a computer processor to produce a compressed lookup table, where the lookup table is based on the query vector and the plurality of quantized key vectors and performing, by the computer, a parallel processing operation using a plurality of SIMD instructions and the lookup table in the SIMD register to determine a plurality of attention scores. The method further includes generating, by the large language model, a predicted sequence of text based on the plurality of attention scores, where the large language model determines the predicted sequence of text using the plurality of attention scores by accessing the compressed lookup tables in the at least one SIMD register.

Embodiments disclosed herein generally relate to a non-transitory computer-readable medium storing instructions that, when executed by a central processing unit, cause the central processing unit (CPU) to perform a method that includes obtaining an input sequence of text comprising a plurality of elements of text, converting each element in the plurality of elements of text into a token, resulting in a plurality of tokens, and transforming each token in the plurality of tokens into a query vector, key vector, and value vector, resulting in a plurality of query vectors, key vectors, and value vectors. The method also includes obtaining a plurality of quantized key vectors by applying product quantization to the plurality of key vectors, and for each query vector, compressing a lookup table into at least one single instruction multiple data (SIMD) register of a plurality of SIMD registers in the CPU to produce a compressed lookup table, where the lookup table is based on the query vector and the plurality of quantized key vectors, and performing a parallel processing operation using a plurality of SIMD instructions and the lookup table in the SIMD register to determine a plurality of attention scores. The method further includes generating a predicted sequence of text based on the plurality of attention scores, where the predicted sequence of text is determined using the plurality of attention scores by accessing the compressed lookup tables in the at least one SIMD register.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts a transformer model in accordance with one or more embodiments.

FIG. 2 depicts a system in accordance with one or more embodiments.

FIG. 3 depicts a flow chart in accordance with one or more embodiments.

FIG. 4 depicts a method in accordance with one or more embodiments.

FIG. 5 depicts data structures in accordance with one or more embodiments.

FIG. 6 depicts data structures in accordance with one or more embodiments.

FIG. 7 depicts data structures in accordance with one or more embodiments.

FIG. 8 depicts a method in accordance with one or more embodiments.

FIG. 9 depicts a method in accordance with one or more embodiments.

FIG. 10 depicts distributions of values in accordance with one or more embodiments.

FIG. 11 depicts a plurality of values on a coordinate grids, in accordance with one or more embodiments.

FIG. 12 depicts a plurality of values on coordinate grids, in accordance with one or more embodiments.

FIG. 13 depicts a plurality of values on coordinate grids, in accordance with one or more embodiments.

FIG. 14 depicts a bar chart in accordance with one or more embodiments.

FIG. 15 depicts a computing system in accordance with one or more embodiments.

### DETAILED DESCRIPTION

In the following detailed description of embodiments of the disclosure, numerous specific details are set forth to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. For example, a “time-domain beat signal” may include any number of “time-domain beat signals” without limitation.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

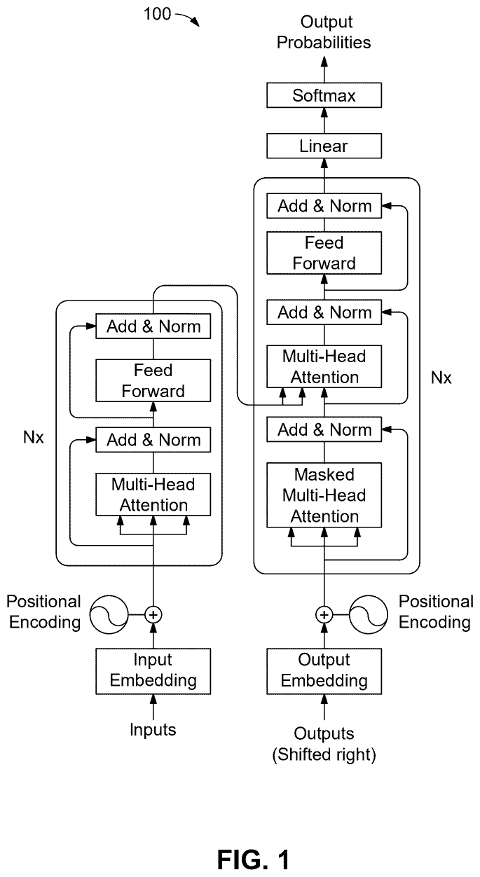

In the following description of FIGS. 1-15, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Large language model inference on Central Processing Units (CPU) is challenging due to the vast quantities of expensive Multiply-Add (MAD) matrix operations in the attention computations. However, there is a rare gem in modern CPUs, Single-Instruction-Multiple-Data (SIMD) registers, which allow for ultra-low latency lookups in batch. This unique capability of CPUs to is exploited by embodiments of the present disclosure that have previously been referred to as NoMAD-Attention (e.g., in U.S. Provisional Patent Application No. 63/559,714). Embodiments of the present disclosure replace MAD operations with in-register lookups (hence the name, “NoMAD-Attention”). In FIGS. 1-15, a reference to “NoMAD” or “NoMAD-Attention” will be understood as referring to one or more elements in accordance with embodiments of the present disclosure.

Through hardware-aware designs, embodiments of the present disclosure may be used to determine attention scores using repeated fast accesses to SIMD registers despite the highly limited sizes of SIMD registers. Moreover, embodiments of the present disclosure work with pre-trained attention-based LLMs without model finetuning. Empirical evaluations, described below under “EXAMPLE,” demonstrate that embodiments of the present disclosure maintain the quality of the original LLMs well, and speed up the 4-bit quantized LLaMA-7B-based model by up to a factor of 2 at 16k context length.

Auto-regressive transformer-based Large Language Models (LLM) have demonstrated remarkable abilities across a wide range of natural language processing tasks including reading comprehension, translation, and question answering. LLMs exhibit emergent abilities in solving complex tasks without fine-tuning. These capabilities give LLMs immense potential for impactful applications in diverse fields such as medicine, law, and robotics. Despite the promising potential of LLMs, their deployment is extremely expensive. Serving LLMs with billion-scale parameters requires specialized hardware such as Nvidia A100 Graphics Processing Units (GPUs). However, mainstream personal devices, such as laptops, are predominately equipped with Central Processing Units (CPUs). As a result, making LLM-related services accessible to everyone remains a major challenge. Reducing the LLM inference latency on CPUs, beyond doubt, has significant implications for its accessibility and adoption.

LLM inference on CPUs is compute-bound and the primary computational bottleneck is the calculation of attention score. Attention, a mechanism that models token interactions through all-pair dot products, heavily relies on the multiply-add (MAD) kernel on processors. The MAD operation involves computing the product of two numbers and adding that product to an accumulator. Within the attention mechanism, MAD plays a crucial role in determining the attention score between tokens and subsequently blending their embeddings based on these scores. The computational cost of attention grows quadratically with the sequence length due to the cumulative MAD operations. Since CPUs have limited parallel cores, they are inefficient for handling highly repetitive and parallel workloads. The extensive MAD operations required by the attention mechanism thus become the primary bottleneck during inference.

FIG. 1 illustrates a schematic diagram of a transformer network architecture (100) in accordance with one or more embodiments. Transformer network architectures (100) are a popular learning model for LLMs. As has been discussed, LLMs are used to interpret and respond to text or written words. An LLM utilizing a transformer network architecture (100) begins by receiving a text-based input, for example, an input sequence that includes elements of text such as sentences. Generally, transformers include an input embedding layer that converts the input text into a numerical vector. More specifically, sequences of texts are “tokenized” by an encoder, which divides a sequence of text into individual components called tokens. Transformers seek to accomplish “next-token prediction” in which, given a sequence of tokens, the subsequent token is generated or predicted. Positional encoding is used to characterize the positional information of tokens in a sequence. Thus, both the meaning of the word itself as well as its position is characterized during encoding.

Transformers (100) utilize a multi-head attention layer to describe the importance of each token in the sequence and the relative importance of preceding and subsequent tokens. Residual connections and normalization layers are used to stabilize the output of the multi-head attention layer. A feed-forward layer, or a small neural network may be used to process tokens at each respective position in the sequence. The feed-forward layer is typically used to process output from one multi-head attention layer such that it is better prepared for another multi-head attention layer. The output of the encoder, which is the encoded text that has been processed to determine the information of each token and their mutual positional relevance, is used as the input for a decoder layer.

A decoder layer includes many of the same features as the encoder layer, including embedding, multi-head attention layers, and normalization layers. A predetermined “start of sequence” token is typically used to begin the output, and the following tokens are determined by the decoder according to the above-described mechanisms. A linear transformation layer may be used to act as a classifier on the output of the decoder, which projects the high-dimensional output (e.g., a tensor) of the decoder into a lower-dimensional (e.g., a vector) classification which is often a collection of words in the vocabulary recognized by the transformer. Finally, a softmax layer may be used to assign probabilities to each element (or class) determined by the linear layer. The element, or word (or class) with the highest probability is selected as the next element in the sequence. These steps repeat until a predetermined “end of sequence” token is determined.

A person of ordinary skill in the art will appreciate that many modifications may be made to the transformer network architecture (100) described above.

The memory hierarchy of modern CPUs has undergone significant evolution, introducing a new type of registers optimized for Single-Instruction-Multiple-Data (SIMD) operations. The SIMD registers vary in size, ranging from 128 bits to 512 bits, and support specialized SIMD instructions for high-throughput parallel processing. Nowadays, SIMD registers have become a standard feature in commodity hardware, including laptops and mobile devices. In this context, in-register lookup refers to the low-latency retrieval of information stored within SIMD registers. Specifically, storing information such as dot-product lookup tables (LUT) within SIMD registers as opposed to cache memory has the potential of accelerating LLM inference.

Embodiments of the present disclosure provide a new approach for speeding up LLM inference by leveraging the unique hard-ware capability of CPUs. Embodiments of the present disclosure replace MAD operations in attention computation with in-register lookups to mitigate the quadratic computational bottleneck of LLM inference on CPUs. In this way, embodiments of the present disclosure significantly speed up LLM inference without sacrificing model quality and are compatible with pre-trained attention-based transformers without finetuning.

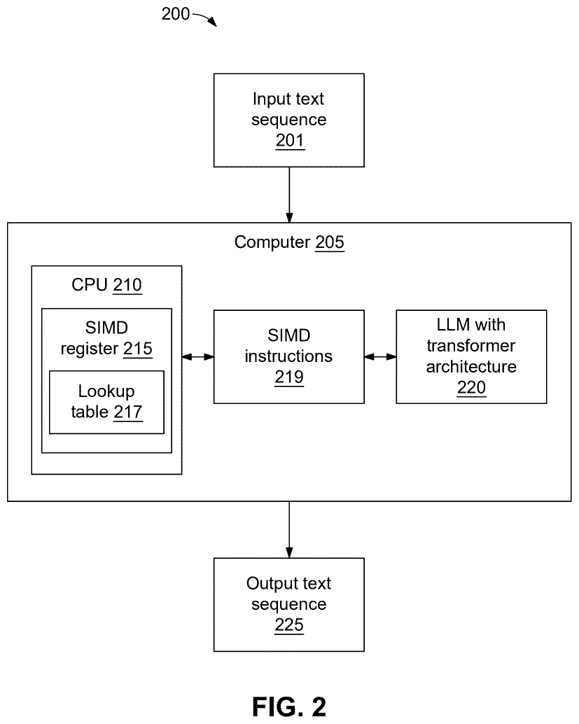

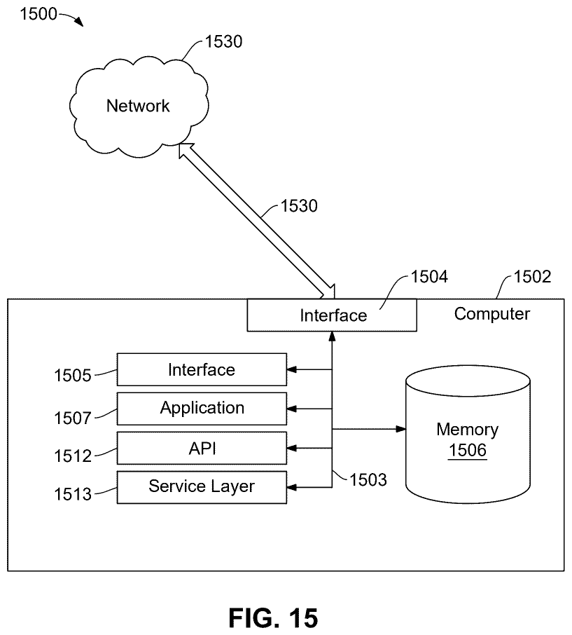

FIG. 2 depicts an LLM system (200) in accordance with one or more embodiments. An input sequence of text (201), or a prompt, is obtained by a large language model (220) in a computer (205). The computer (205) may be the same or similar to the computer system (1502) described below in reference to FIG. 15. The LLM (220) uses a transformer network architecture similar to the transformer network architecture (100) depicted in FIG. 1.

The input sequence of text (201) comprises a plurality of elements of text. LLMs, such as the LLM (220) of FIG. 2, are trained on extremely large bodies of text that typically include books, scientific articles and journals, and web pages, for example. Consequently, LLMs are able to perform many tasks with respect to natural language such as translation, answering questions, providing summaries, or otherwise creating new content depending on the input sequence of text (201). As described in greater detail below, the input sequence of text (201) is processed by the LLM (220), and information related to the input sequence of text (201) is recorded within a lookup table (217) stored on at least one SIMD register (215) of a CPU. The LLM (220) in the computer (205) interacts with at least one SIMD register (215) using SIMD instructions (219) to generate a predicted sequence of text, or an output sequence of text (225), by accessing the at least one SIMD register (215) of the CPU (210). The output sequence of text (225) is based on the input sequence of text (201) and depends on its content.

In accordance with one or more embodiments, the input sequence of text (201) may be a computer executable program in addition to a prompt which describes how the computer executable program should be processed by the LLM (220). For example, in one instance, the computer executable program may include malicious code, and the prompt may include a request for the LLM (220) to identify and remove the malicious code. Then, an output sequence of text (225) may be generated by the LLM (220) that includes a new computer executable program (based on the computer executable code that was inputted) but without the malicious code. As such, embodiments of the present disclosure may include workflows and methods for building computer executable programs and safely operating systems that execute the computer executable programs.

As another example, the input sequence of text (201) may include a prompt that consists of a request for the LLM (220) to generate information (e.g., formatted text, such as a table) to be displayed on a web browser. An output sequence (225) of text may then be generated by the LLM (220) that includes the code (e.g., in the programming language HTML, or another programming language) for displaying the requested information on a web browser. As such, embodiments of the present disclosure may include workflows and methods for web design and for efficiently creating content to be displayed on web browsers.

As another example, the input sequence of text (201) may include a transcript of a conversation or speech as well as a prompt that includes a request for the LLM (220) to identify and correct inaccuracies or false statements within the input sequence of text (201). Then, an output sequence of text (225) may be generated by the LLM (220) that includes the transcript with the inaccuracies corrected or false statements identified and corrected. As such, embodiments of the present disclosure may include recording systems such as those used at recording studios or in-home offices to provide improved transcripts.

As described in greater detail below, the methods for operating the LLM (220) are applicable to the easily accessible and ubiquitous central processing unit (CPU) and do not require the more expensive processors ordinarily associated with LLMs (e.g., GPUs and TPUs). Thus, in view of the above, the embodiments of the present invention may significantly improve a variety of applications involving the use of LLMs (220) on CPUs (210), for example, workflows and methods for building computer executable programs and safely operating systems that execute the computer executable programs, workflows and methods for web design and for efficiently creating content to be displayed on web browsers, and methods involving recording systems such as those used at recording studios or in-home offices, and other examples not listed. Thus, as will be understood by those of ordinary skill in the art, embodiments of the present invention improve operation of LLMs (220) on CPUs (210) generally.

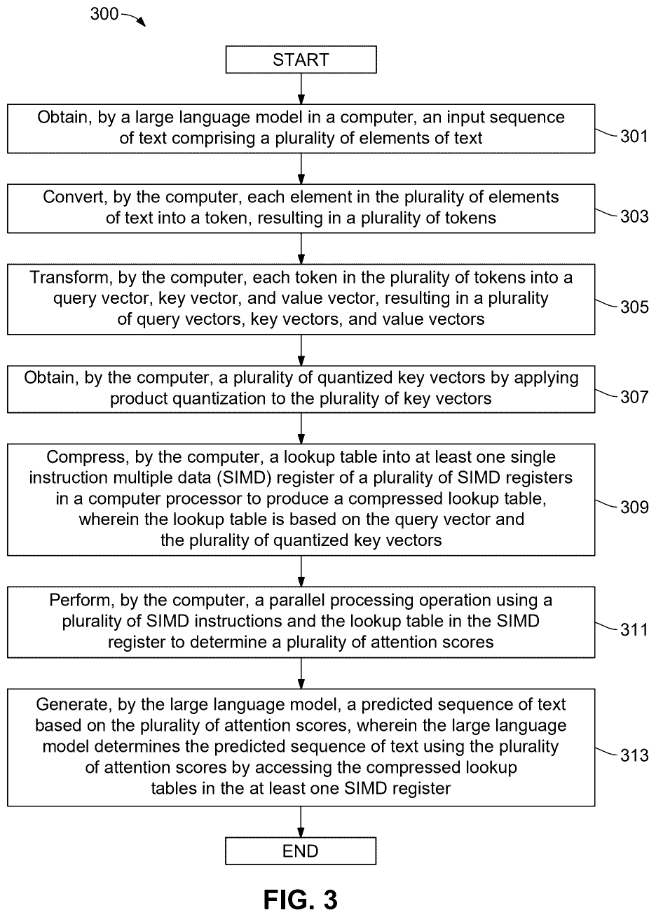

A method in accordance with one or more embodiments is summarized in the flow chart of FIG. 3. In Block 301, an input sequence comprising a plurality of elements of text, or an input sequence of text (201) is obtained by a LLM (220) in a computer (205). As described above, the input sequence of text (201) may include a question to be answered by the LLM (220) or a passage of text to be summarized by the LLM (220), for example.

In Block 303, each element in the plurality of elements of text is converted by the computer into a token, resulting in a plurality of tokens. As described above, this process is generically referred to as “tokenization.” A full explanation of tokenization is beyond the scope of this disclosure. In short, a token may include a single text character, multiple text characters, single words, and multiple words. Often, a specific token is designates the beginning of a sequence of text or the end of a sequence of text.

In Block 305, each token in the plurality of tokens is transformed by the computer into a query vector, key vector, and value vector, resulting in a plurality of query vectors, key vectors, and value vectors. Query vectors are considered by the LLM sequentially, one after the other. Generally, a query vector represents the current token for which the LLM (220) is attempting to find relevant information for in a given iteration. The query vector is generally compared with the key vectors to determine the relevance of other tokens in the sequence. The value vector holds encoded information related to each token. The plurality of query vectors, key vectors, and value vectors are used to determine attention in LLMs (220), in accordance with one or more embodiments.

To promote a basic understanding, a description of the attention mechanism used in LLMs and the key-value (KV) caching technique for avoiding redundant attention computations is provided. In addition, the CPU memory hierarchy, which serves as the motivation for performing fast in-register lookups, is described.

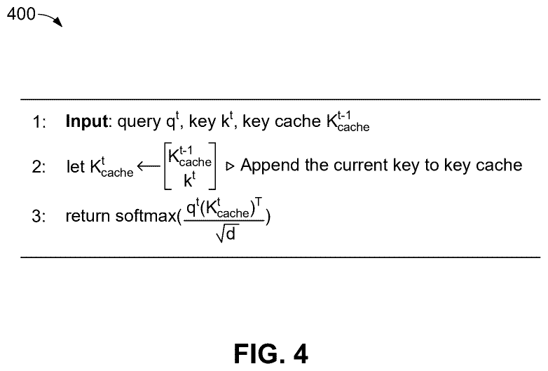

FIG. 4 presents a method for attention score computation (400), including key caching, for a single-head masked self-attention in LLM. This method will serve as a point of comparison for other methods described herein.

Most LLMs are decoder-only attention-based models that are pre-trained on a next token prediction objective. LLMs use masked self-attention, in which the attention output of each token is only dependent on previous tokens and itself, and unaffected by future tokens. Masked self-attention allows LLMs to cache key and value embeddings, avoiding future recomputations. However, this comes at the cost of memory overhead. The autoregressive generation of LLMs consists of two phases: 1) prompt processing, in which the sequence of token embeddings in the prompt is fed through by the model, and their key-value embeddings are cached by the model, and 2) decoding, in which a new token is sampled based on the output embedding of the last token, and the embedding of the new token is fed through the model, the output of which becomes the basis for sampling the next token. The decoding process continues until an end-of-sequence token <EOS> is sampled.

At the decoding step t, a single-head masked self-attention computes its output in the following way. The embedding of the current token et is transformed into key, query, and value embeddings through distinct transformations,

$${k}^{t} = {f}_{k} ( {e}^{t} ) , {q}^{t} = {f}_{Q} ( {e}^{t} ) , {v}^{t} = {f}_{V} ( {e}^{t} ) .$$

Then, the key and value embedding of the current token are appended to the key and value cache, respectively. The KV cache K_{cache}^{t-1}, V_{cache}^{t-1} of the step t−1 contains the key/value embeddings of all previous tokens, and after appending, the KV cache become

$${K}_{cache}^{t} = [ \begin{matrix}{K}_{cache}^{t - 1} \\ {k}^{t}\end{matrix} ] = [ \begin{matrix}{k}^{1} \\ {k}^{2} \\ ... \\ {k}^{t}\end{matrix} ] , {V}_{cache}^{t} = [ \begin{matrix}{V}_{cache}^{t - 1} \\ {v}^{t}\end{matrix} ] = [ \begin{matrix}{v}^{1} \\ {v}^{2} \\ ... \\ {v}^{t}\end{matrix} ] .$$

Finally, the attention output is computed as,

$$attention ( {e}^{t} ) = soft max ( \frac{{{q}^{t} ( {K}_{cache}^{t} )}^{T}}{\sqrt{d}} ) {V}_{cache}^{t}$$

where d is the dimensionality of q^{t}. The result of softmax

$$( \frac{{qK}^{T}}{\sqrt{d}} )$$

is referred to as the attention scores since they dictate how much “attention” each token pays to other tokens. Computations in the prompt processing phase are similar to the decoding phase, except all the prompt tokens are computed in batch. LLMs use multi-head attention, which transforms the concatenation of the outputs of multiple single-head attentions to form an output embedding.

The attention mechanism models the interaction between tokens by performing all-pair dot products, where each dot product is computed via d Multiply-Add (MAD) operations. Since attention computes the interaction between all pairs of tokens exhaustively, the amount of MAD operations scales quadratically with the sequence length, quickly overwhelming the computing capability of CPUs (210). CPUs (210) are designed to handle complex workloads with granular control, while GPUs are optimized for processing simple and repetitive tasks in high through-put. Hence the success of attention has largely been fueled by the development of highly parallel throughput-oriented processors such as GPUs.

The computation of attention scores becomes the bottleneck of LLM inference as the sequence length increases. At the t-th step of the decoding phase, the time complexity of computing attention score with MAD is O(t) due to t dot products, while all other components of LLMs such as MLP, skip connections, and normalization have time complexity O(1).

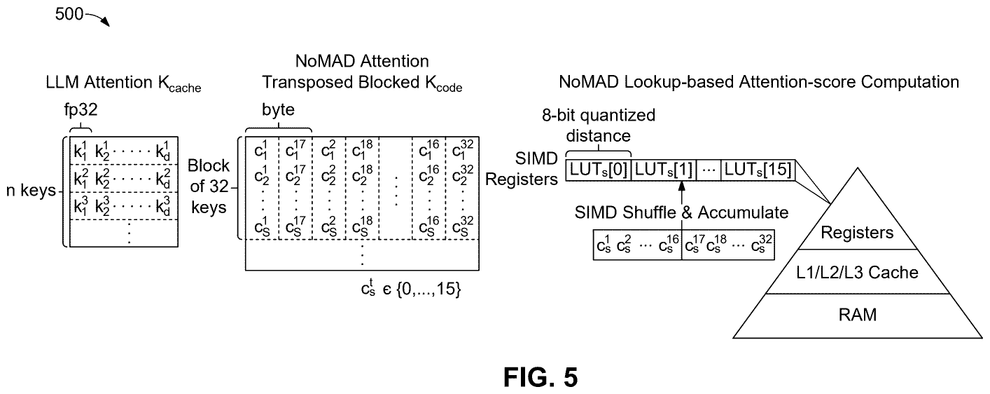

FIG. 5 depicts a plurality of data structures (500) in accordance with one or more embodiments. More specifically, FIG. 5 depicts an illustrative comparison of memory layouts of the key cache of LLM attention and the key-code cache of embodiments of the present disclosure (referred to therein as “NoMAD-Attention”), and an illustration of how attention scores are computed through in-register lookups according to embodiments of the present disclosure. Memory of the CPU (210) is organized into a pyramidal hierarchy as shown in FIG. 5, with faster memory being significantly smaller than slower memory. The memory unit with the fastest access speed is registers. Each compute core can access its dedicated registers in just 1-2 CPU cycles, but these registers are highly limited in size, usually not exceeding 64 bits. Modern processors have a new type of registers optimized for Single-Instruction-Multiple-Data (SIMD) operations. These SIMD registers (215) range from 128 bits to 512 bits in size and support specialized SIMD instructions for throughput-oriented parallel processing. SIMD registers (215) are common on commodity hardware, including laptops and mobile devices. Using SIMD operations can speed up deep learning models on CPUs (210) by parallelizing matrix multiplications. However, due to the limited number of cores in a CPU (210), its efficiency in deep learning is still considerably worse than GPU. Prior works have resorted to sparsity and sampling-based approaches to reduce the number of computations for efficient deep learning on CPU, but they require training models from scratch and may not apply to all architectures. Embodiments of the present disclosure exploit the SIMD registers (215) to shift the computation paradigm from MAD to in-register lookups, which demonstrates significant speedup over MAD-based alternatives.

Embodiments of the present disclosure generally assume SIMD registers (215) are 128 bits wide. However, one or more embodiments may also use wider SIMD registers (215) that support more parallelism, e.g. 256 bit registers in AVX-2 and 512-bit registers in AVX-512. However, the most universal form of SIMD registers (215) uses 128 bits, which is supported, for example, by Arm NEON and AVX-compatible processors.

As discussed above, embodiments of the present disclosure replace MAD operations with in-register lookups to enable fast attention computations on CPUs (210). In general, embodiments of the present disclosure utilize three primary techniques to enable lookup-based attention: 1) transforming dot product computations to memory lookups through product quantization, 2) compressing lookup tables into SIMD registers (215) for low-latency access, and 3) reorganizing the memory layout of key cache for batch parallel dot product lookups.

Returning to FIG. 3, in Block 307, a plurality of quantized key vectors are obtained by the computer by applying product quantization to the plurality of key vectors. Further detail, in accordance with one or more embodiments, is provided below.

Previous works have shown that inexact attention scores in transformers work well for sequence modeling. Based on this insight, embodiments of the present disclosure leverage Product Quantization (PQ) to compute high-quality estimations of dot products through register lookups. PQ, originally designed for compressing high-dimensional vectors to enable efficient nearest-neighbor search, quantizes a floating-point vector into discrete codes. It makes use of sub-quantizers; for a d-dimensional vector space, a vector is divided evenly in dimension into S sub-vectors, where each sub-vector has dimension

$${d}_{sub} = \frac{d}{S}$$

and each sub-vector space is quantized independently. A sub-quantizer πₛ(e) is used, where s∈{1 . . . . S}, to denote the function that maps a d-dimensional vector e to its d_{sub}-dimensional sub-vector of the s-th sub-quantizer. Codebooks are used to quantize sub-vectors to codes, which are collections of cluster centroids learned from a set of training vectors. Herein, b_{s,c} is used to denote the c-th centroid in the codebook of the s-th sub-quantizer. For a given vector e, the product-quantized codes of e, denoted c₁, . . . , cₛ, are the indexes of the nearest centroid of each sub-quantizer, i.e.,

$$PQ ( e ) = [ {c}_{1} ... {c}_{S} ] , where {c}_{s} = arg {min}_{c} ‖ {π}_{s} ( v ) - {b}_{s , c} ‖ .$$

Once base vectors have been product-quantized to codes, PQ leverages asymmetric distance computation to keep the estimation error low. In the computed distances, the original query vector is used while the quantized base vectors are used, hence the asymmetry. For a given query q, the distances to the centroids of each sub-quantizer are computed and stored in a lookup table (LUT). Then, the corresponding distances in the LUT are looked up based on the codes of base vectors, and accumulated to produce the final distance estimation. Specifically, denoting the distance between query q and the c-th centroid for the s-th sub-quantizer using LUTₛ[c]=dist(πₛ(q)b_{s,c}), then the estimated distance between query q and a product-quantized base vector e, where PQ(e)=[c₁ . . . . cₛ], is

$$( q , e ) = {\sum }_{s = 1}^{S} {LUT}_{s} [ {c}_{s} ] .$$

PQ, which works for metric distances, is extended herein to estimate dot products for attention, in accordance with one or more embodiments. In particular product-quantization is applied to the key vectors in attention to produce key codes, which are stored in place of the key cache in LLM attention. The codebooks are learned by performing clustering on a set of key vectors from a training set. The key vectors are quantized to the nearest centroid with respect to L2 distance. For a given query, the query-dependent LUT is computed to hold dot products with respect to centroids. Dot products of sub-vectors are retrieved from the LUT based on key codes and accumulated to produce the final dot product estimates. This procedure enables computation of attention scores through lookups.

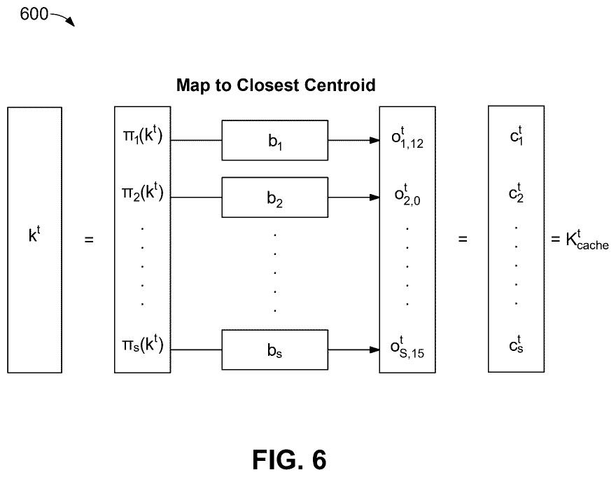

FIG. 6 depicts data structures of key vectors (600) in accordance with one or more embodiments. In particular, FIG. 6 depicts an illustration demonstrating the mapping of an input key vector k^{t} to its s-th sub-quantizer using π_{S}(k^{t}), where s∈{1 . . . . S}. The key vector is split into sub-vectors k^{t}=(π₁(k^{t}), π₂(k^{t}), . . . , π_{S}(k^{t})). Subsequently, each sub-quantizer maps to its closest centroid cᵢ^{t} by referencing the codebook bₛ, where i∈{1 . . . . S} among 16 centroids in the codebook. The results are stored in the key cache K_{cache}^{t-1}.

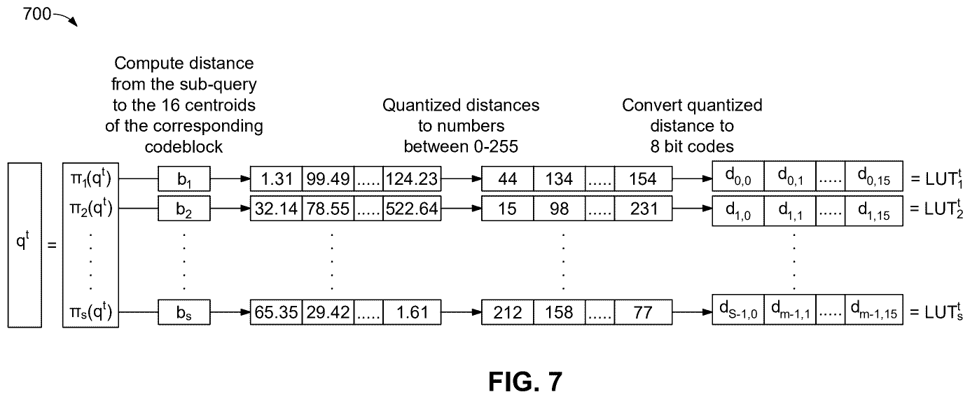

Similarly, FIG. 7 depicts data structures of query vectors (700) in accordance with one or more embodiments. In particular, FIG. 7 depicts an illustration depicting the mapping of a query vector q^{t} to its s-th sub-quantizer using πₛ(q^{t}), where s∈{1 . . . . S}. Given a query vector q^{t}, functions πₛ, where s∈{1 . . . . S}, split the query into sub-queries q^{t}=(π₁(q^{t}), π₂(q^{t}), . . . , π_{S}(q^{t})). Subsequently, the distances between each sub-query πₛ(q^{t}) and the 16 centroids from the codebook bₛ are computed and then quantized to values within the range 0-255. Lastly, the quantized vectors are converted into 8-bit codes and stored in LUTₛ^{t}.

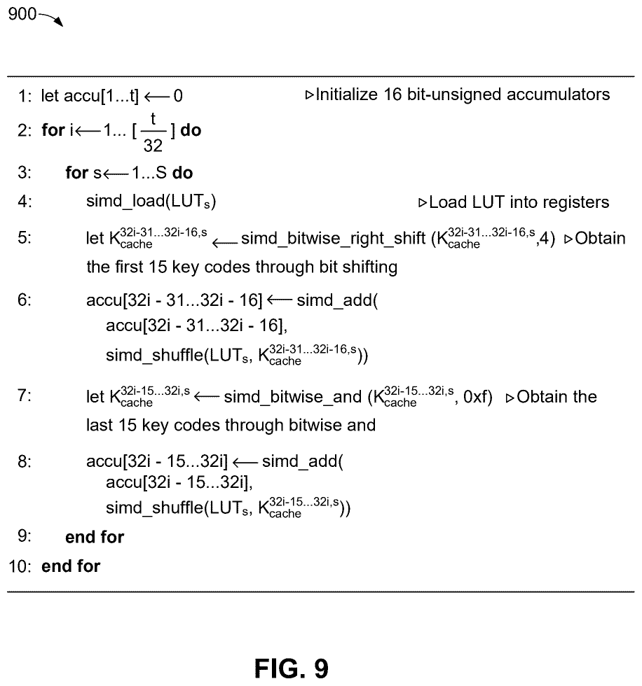

Estimating dot products through PQ mostly eliminates the use of MAD kernels in the computation of attention scores. However, this approach yields limited speedup over dot-product attention since a high proportion of the CPU cycles are wasted due to cache/memory access stalling (FIG. 9 offers a comparison between the speed of PQ and dot product operations). It has been shown that even L1-cache-resident LUT is not enough to offer high-performance PQ. The full potential of lookup-based attention can only be unlocked by having the LUT stored in registers, which take only 1-2 CPU cycles to access. However, the highly limited size of registers poses a challenge to fitting the LUT. In PQ, each sub-quantizer commonly uses 256 centroids, which translates to 8-bit codes. Combined with 32-bit floating-point (FP32) dot products, the LUT for each sub-quantizer consumes 8192 bits of memory while the SIMD registers (215) are only 128 bits wide in accordance with one or more embodiments. However, embodiments of the present disclosure may include larger SIMD registers that are, for example, 256 bits wide. To circumvent this limitation in register size, hardware-aware techniques proposed by are expanded upon to enable low-latency retrieval from register-resident LUT.

Returning to FIG. 3, Blocks 309 and 311 are applied for each query vector in the plurality of query vectors. At Block 309, a lookup table (217), or LUT, is compressed into at least one SIMD register (215) of a plurality of SIMD registers (215) in a computer processor to produce a compressed lookup table. The lookup table (217) is based on the query vector and the plurality of quantized key vectors. Further detail, in accordance with one or more embodiments, is provided below.

Due to the mere 128-bit width of SIMD registers (215), the FP32 representation of dot product is too costly to store. Adopting FP32 dot products in LUT (217) implies that each codebook can only contain up to 4 centroids, which will no doubt lead to significant quantization errors. Therefore, 8-bit dynamically quantized representation of dot products are used. Compressing beyond 8-bit is infeasible since many SIMD instruction sets do not support parallel lookups below 8 bits. The quantization is done dynamically for each query to minimize quantization errors. For a given query and sub-quantizer, dot products to centroids are first computed in full FP32 precision. Then the quantization range is determined by the minimum and maximum dot products to the centroids. Finally, the range is evenly divided into 2⁸ buckets and dot products are quantized to the bucket they fall into. More formally, suppose dpₘᵢₙ=min_{c}(πₛ(q)·b_{s,c}) and dpₘₐₓ=max_{c}(πₛ(q)·b_{s,c}) are the minimum and maximum dot products of the query q to the centroids of the s-th sub-quantizer, then the LUT (217) stores the quantized dot products to centroid c as

$${LUT}_{s} [ c ] = ⌊ \frac{( {π}_{s} ( q ) \cdot {b}_{s , c} ) - {dp}_{min}}{( {dp}_{max} - {dp}_{min} ) / {2}^{8}} ⌋ .$$

The quantization and de-quantization process can be done efficiently without much computational overhead, and the quantization error is kept low thanks to dynamic query-dependent quantization.

By adopting 8-bit quantized dot products in LUT (217), 16 dot products can fit on 128-bit SIMD registers (215). This implies that the codebook size of each sub-quantizer is constrained to 16 centroids. Although the codebook seems limited in size, some evidences suggest it may work well with attention. It has been shown that the output of attention loses rank extremely quickly, implying that the intermediate embeddings of transformers may exhibit clear clustering structures.

Quantized dot products and constrained codebooks enable LUT (217) to be stored in SIMD registers (215), but the layout format of the key cache needs to be reorganized to take advantage of SIMD instructions. The original key cache in LLM attention stores each key vector contiguously in a row to optimize single vector reads. Embodiments of the present disclosure use the key-code cache in place of the key cache, which stores the quantized codes of keys. To allow fast lookups of LUT (217) entries based on key codes, key codes are stored in a transposed blocked format. An illustrative comparison between the LLM key cache and the key-code cache in accordance with embodiments of the present disclosure is given in FIG. 3.

In Block 311, a parallel processing operation is performed by the computer using a plurality of SIMD instructions (219) and the lookup table (217) in the SIMD register (215) to determine a plurality of attention scores. The storage format of the key-code cache, in accordance with one or more embodiments, is transposed: stored in column-major order instead of row-major, and blocked: with 32 keys as a block. One of the SIMD instructions (219), shuffle, which we leverage for performing low-latency batch lookups, takes a batch of byte-size integers as input and retrieves the values held in the registers corresponding to the integer indices. The original storage format of the key cache stores all dimensions of a key contiguously, which does not allow efficient use of shuffle. To maximize the usage of the LUT (217) held in registers, we store key codes belonging to the same sub-quantizer contiguously in rows of 32 codes. Since shuffleperforms lookups in a batch size of 16, the keys within the same block are stored in alternating order. This is because each quantized code occupies half a byte as there are 16 centroids in a codebook, while the shuffle instruction uses each byte as an input argument. By performing SIMD bit-shifting and bit-masking on a block of alternating keys, we obtain the key codes in the original order, ready for use with shuffle.

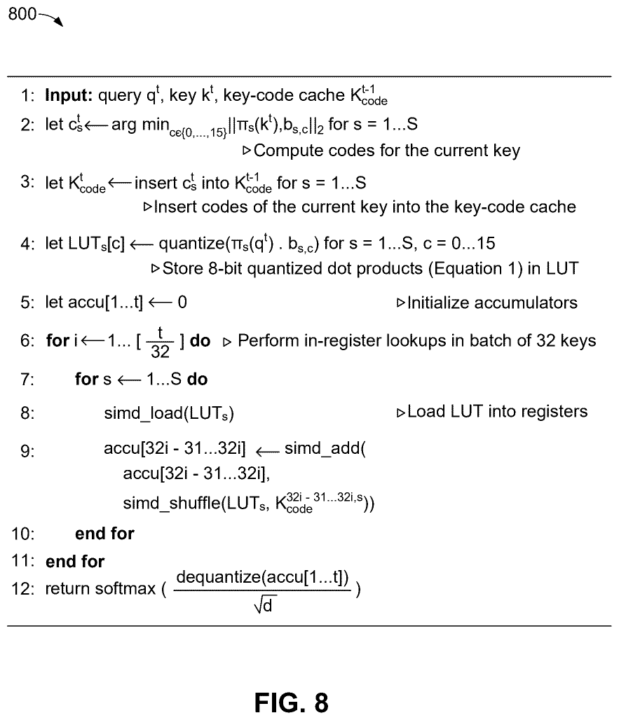

By combining these three techniques, embodiments of the present disclosure achieve fast MAD-free attention score computations through SIMD in-register lookups. For a given query, first, LUTs (217) with 8-bit quantized dot products are computed for each sub-quantizer. Then, a LUT (217) is loaded into SIMD registers (217), followed by SIMD shuffleinstructions (219) to retrieve dot products in the LUT (217) in batch based on key codes. The loading and lookup are repeated for all sub-quantizers, and the retrieved dot products are accumulated in batch through the SIMD instruction (219) add. Finally, the quantized dot products accumulated over all sub-quantizers are de-quantized, scaled, and fed through softmax to produce the attention scores. A method for “NoMAD-Attention” score computation (800) is shown in FIG. 8, in accordance with embodiments of the present disclosure.

The SIMD shuffle instruction (219) presented in FIG. 8 is a simplification of the actual hardware implementation. Full details of lines 5 to 11 in FIG. 8 are provided in FIG. 9, in accordance with embodiments of the present disclosure. Keys are stored in blocks of 32, in which keys are stored in an alternating order (see FIG. 5 for an illustration). After a LUT (217) is loaded into SIMD registers (215), the row of key codes in the block corresponding to the sub-quantizer is used to perform shuffle. First, each byte in the row is bit-shifted to the right by 4 bits via a SIMD instruction (219), which produces the codes of the first 16 keys in the block. The codes are fed to shuffle to retrieve the quantized dot products of the first 16 keys from the LUT (217). Then, the first 4 bits of each byte in the row are masked out via a SIMD instruction (219), which produces the code of the last 16 keys in the block. They are similarly used to retrieve the quantized dot products from the LUT (217). The retrieved quantized dot products of 32 keys are accumulated in the accumulator. Since quantized dot products are 8 bits wide, accumulating them in 8-bit accumulators easily results in overflows. Therefore, 16-bit accumulators are used to accumulate quantized dot products.

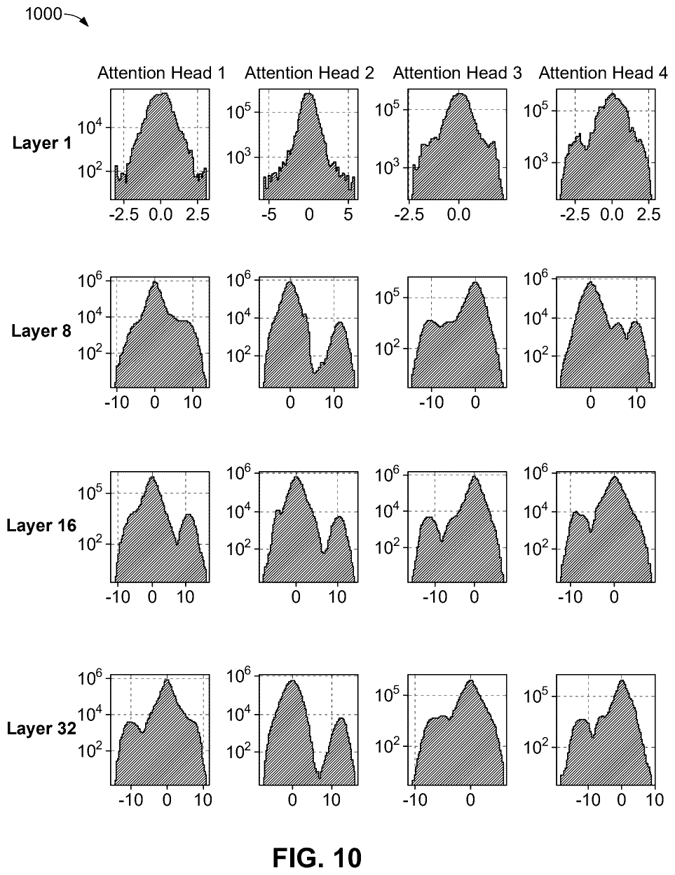

Compressing each segment of the attention key into a 4-bit code requires careful initialization of centroids to avoid high quantization errors, which can lead to degradation in model quality. Ideally, centroids in the codebooks should have low L2 distance to the attention key sub-vectors of the corresponding sub-quantizer. Empirically, it is observed that the value distributions in attention key embeddings vary significantly for each attention head and layer. For example, FIG. 10 illustrates the value distributions in attention key embeddings (1000) of the LLaMA-2-7B model on samples from the WikiText-2 dataset in accordance with one or more embodiments. Distinct attention heads have different value ranges and distributional skew. The first 4 attention heads in 4 different layers are shown, and all 128 dimensions of the key embeddings are used. Key embeddings have different distributions in value across different layers and heads, making it necessary for codebooks to be learned independently for each layer and head to minimize quantization error.

Hence, embodiments of the present disclosure include learning codebooks for key compression in the following way: first LLM inference is performed with the original attention on a learning set of data and the attention key embeddings for each layer and head are recorded. Subsequently, codebook centroids for key compression are learned by clustering the key embeddings, for example, through a K-Means-based algorithm (or another suitable clustering algorithm) on each attention head independently. These centroids become the codebooks for compressing the key-code cache.

Returning to FIG. 3, in Block 313, a predicted sequence of text, our output sequence of text (225), is generated by the large language model (220) based on the plurality of attention scores. The large language model (220) determines the predicted sequence of text using the plurality of attention scores by accessing the compressed lookup tables in the least one SIMD register (215). The output sequence of text (225) depends directly on the input sequence of text (201), and includes the answer to a question posed to the LLM (220) as a prompt, or the summary of a passage of text that was requested to be summarized by the LLM (220), for example.

A person of ordinary skill in the art will recognize that many modifications can be made to improve the methods and systems disclosed herein to take advantage of wider SIMD registers (215) and hardware-specific features to achieve greater LLM inference speedups. In addition, the disclosed methods and systems can be extended to work with more processor types such as GPUs, FPGAs, and TPUs to speed up and exploit memory compression as has been done with CPUs.

Embodiments of the present disclosure may provide at least one of the following advantages. Embodiments of the present disclosure address the challenges of large language model inference on CPUs (210), particularly the difficulties associated with the expensive Multiply-Add (MAD) matrix operations in attention mechanisms. Embodiments of the present disclosure are thus directed to one or more improvements in the functioning of a computer, in particular, in a computer CPU.

Embodiments of the present disclosure showcase the untapped potential of SIMD registers (215) and their fast in-register lookup capabilities within CPUs (215). Embodiments of the present disclosure thereby provide an efficient alternative to traditional MAD-based approaches, leveraging in-register lookups and optimizing memory access to SIMD registers (215). For example, the implementation of embodiments of the present disclosure results in a significant acceleration of LLaMA-7B-based model inference, achieving up to a 2 times speedup on CPUs as shown in the example below. This underscores the importance of exploring novel approaches, such as embodiments described herein, to enhance the efficiency of large language model inference on CPU (210) architectures.

Embodiments of the present disclosure democratize large LLMs by enabling their operation on CPU (210) cores, making them accessible to a broader audience. By successfully demonstrating the implementation of an LLM (220) on CPU (210), embodiments of the present disclosure contribute to fostering innovation and expansion of cutting-edge LLM technologies to a wider user base.

The methods and systems of the present disclosure may be used in any environment, commercial application, research setting, or industry that wishes to utilize LLMs using fewer hardware resources without needing costly GPUs or TPUs. Methods and systems of the present disclosure overcome a large financial barrier of entry many companies face when trying to develop or utilize modem LLMs which mostly require multiple GPUs with a combined cost of tens of thousands of dollars. Embodiments of the present disclosure can run such LLM operations without reliance on costly hardware resources.

Embodiments of the present disclosure represent the first practical implementation of modern LLMs (220) on CPUs (210), and also the first application to reliably shift the computational paradigm of LLMs from multiply-add (MAD) to lookups. Additionally, embodiments of the present disclosure are the first to fully utilize SIMD registers (215) for LLM inference using instructions and methods specific to the hardware restrictions of SIMD registers (215).

In one aspect, the strength and utility of the methods and systems disclosed herein come from the minimal hardware requirements, using CPUs (210) for LLM inference instead of GPUs as is typically required for LLM inference. This massively lowers the hardware cost of computing LLM inference and offers an alternative for small companies that cannot afford the current GPU requirements of LLMs. Yet further, the methods and systems disclosed herein may allow individuals to run LLM inference on their personal computers. Additionally, methods and systems disclosed herein can be implemented to enable LLMs to be served with cheap commodity hardware and drastically reduce service costs for companies.

Embodiments disclosed herein may be implemented on a computer system. FIG. 15 is a block diagram of a computer system (1502) used to provide computational functionalities associated with described algorithms, methods, functions, processes, flows, and procedures as described in the instant disclosure, according to one or more embodiments. The computer system (1502) may be the same or similar to the computer (205) depicted in FIG. 2.

The illustrated computer (1502) is intended to encompass any computing device such as a server, desktop computer, laptop/notebook computer, wireless data port, smart phone, personal data assistant (PDA), tablet computing device, one or more processors within these devices, or any other suitable processing device such as an edge computing device, including both physical or virtual instances (or both) of the computing device. An edge computing device is a dedicated computing device that is, typically, physically adjacent to the process or control with which it interacts.

Additionally, the computer (1502) may include a computer that includes an input device, such as a keypad, keyboard, touch screen, or other device that may accept user information, and an output device that conveys information associated with the operation of the computer (1502), including digital data, visual, or audio information (or a combination of information), or a GUI.

The computer (1502) may serve in a role as a client, network component, a server, a database or other persistency, or any other component (or a combination of roles) of a computer system for performing the subject matter described in the instant disclosure. In some implementations, one or more components of the computer (1502) may be configured to operate within environments, including cloud-computing-based, local, global, or other environment (or a combination of environments).

At a high level, the computer (1502) is an electronic computing device operable to receive, transmit, process, store, or manage data and information associated with the described subject matter. According to some implementations, the computer (1502) may also include or be communicably coupled with an application server, e-mail server, web server, caching server, streaming data server, business intelligence (BI) server, or other server (or a combination of servers).

The computer (1502) may receive requests over network (1530) from a client application (for example, executing on another computer (1502) and responding to the received requests by processing the said requests in an appropriate software application. In addition, requests may also be sent to the computer (1502) from internal users (for example, from a command console or by other appropriate access method), external or third-parties, other automated applications, as well as any other appropriate entities, individuals, systems, or computers.

Each of the components of the computer (1502) may communicate using a system bus (1503). In some implementations, any or all of the components of the computer (1502), both hardware or software (or a combination of hardware and software), may interface with each other or the interface (1504) (or a combination of both) over the system bus (1503) using an application programming interface (API) (1512) or a service layer (1513) (or a combination of the API (1512) and service layer (1513). The API (1512) may include specifications for routines, data structures, and object classes. The API (1512) may be either computer-language independent or dependent and refer to a complete interface, a single function, or even a set of APIs. The service layer (1513) provides software services to the computer (1502) or other components (whether or not illustrated) that are communicably coupled to the computer (1502). The functionality of the computer (1502) may be accessible for all service consumers using this service layer. Software services, such as those provided by the service layer (1513), provide reusable, defined business functionalities through a defined interface. For example, the interface may be software written in JAVA, C++, or other suitable language providing data in extensible markup language (XML) format or another suitable format. While illustrated as an integrated component of the computer (1502), alternative implementations may illustrate the API (1512) or the service layer (1513) as stand-alone components in relation to other components of the computer (1502) or other components (whether or not illustrated) that are communicably coupled to the computer (1502). Moreover, any or all parts of the API (1512) or the service layer (1513) may be implemented as child or sub-modules of another software module, enterprise application, or hardware module without departing from the scope of this disclosure.

The computer (1502) includes an interface (1504). Although illustrated as a single interface (1504) in FIG. 15, two or more interfaces (1504) may be used according to particular needs, desires, or particular implementations of the computer (1502). The interface (1504) is used by the computer (1502) to communicate with other systems in a distributed environment that are connected to the network (1530). Generally, the interface (1504) includes logic encoded in software or hardware (or a combination of software and hardware) and operable to communicate with the network (1530). More specifically, the interface (1504) may include software supporting one or more communication protocols associated with communications such that the network (1530) or interface's hardware is operable to communicate physical signals within and outside of the illustrated computer (1502).

The computer (1502) includes at least one computer processor (1505). Although illustrated as a single computer processor (1505) in FIG. 15, two or more processors may be used according to particular needs, desires, or particular implementations of the computer (1502). Generally, the computer processor (1505) executes instructions and manipulates data to perform the operations of the computer (1502) and any algorithms, methods, functions, processes, flows, and procedures as described in the instant disclosure. As described above, the computer processor (1505) according to one or more embodiments of the disclosure may be a central processing unit (CPU). However, embodiments of the present disclosure are applicable to other types of processors that include SIMD registers as well.

The computer (1502) also includes a memory (1506) that holds data for the computer (1502) or other components (or a combination of both) that may be connected to the network (1530). The memory may be a non-transitory computer readable medium. For example, memory (1506) may be a database storing data consistent with this disclosure. Although illustrated as a single memory (1506) in FIG. 15, two or more memories may be used according to particular needs, desires, or particular implementations of the computer (1502) and the described functionality. While memory (1506) is illustrated as an integral component of the computer (1502), in alternative implementations, memory (1506) may be external to the computer (1502).

The application (1507) is an algorithmic software engine providing functionality according to particular needs, desires, or particular implementations of the computer (1502), particularly with respect to functionality described in this disclosure. For example, application (1507) may serve as one or more components, modules, applications, etc. Further, although illustrated as a single application (1507), the application (1507) may be implemented as multiple applications (1507) on the computer (1502). In addition, although illustrated as integral to the computer (1502), in alternative implementations, the application (1507) may be external to the computer (1502).

There may be any number of computers (1502) associated with, or external to, a computer system containing computer (1502), wherein each computer (1502) communicates over network (1530). Further, the term “client,” “user,” and other appropriate terminology may be used interchangeably as appropriate without departing from the scope of this disclosure. Moreover, this disclosure contemplates that many users may use one computer (1502), or that one user may use multiple computers (1502).

### Example

In this section, the effectiveness of embodiments of the present disclosure in maintaining model quality and achieving efficient LLM inference on CPUs is described. In particular, the following are considered: 1. the model quality of LLMs operating according to embodiments of the present disclosure compared to the original, standard LLMs, and 2. the efficiency of LLMs operating according to embodiments of the present disclosure compared to attention-based LLMs. First the software implementation and testbed hardware are described, followed by details of the experiment setup and baseline methods and finally the experimental results.

The software system is built in C and C++, based on the open-source projects llama.cpp and FAISS. Experiments are performed on a server running Linux Ubuntu 20.04, equipped with 2 Intel Xeon E5-2695 V3 14-core CPUs, 512 GB of DDR4 RAM, and 1 TB of SSD. The processors used support AVX2 SIMD instructions, which we leverage to perform in-register lookups according to embodiments of the present disclosure.

A set of experiments are performed to measure the model quality of LLMs operating according to embodiments of the present disclosure compared to baselines. Model quality is measured using the perplexity metric (lower the better), which is defined as

$$PPL ( x ) = exp ( - \frac{1}{T} {\sum }_{i = 1}^{T} log P ( {x}_{i} \vert {x}_{< i} ) )$$

where x={xᵢ}_{1≤i≤T} is a sequence of target tokens, and P(xᵢ|x_{<i}) is the probability of token xᵢ being predicted by the model conditioned on the previous tokens x_{<i} as context. Perplexity is measured on the test set of two datasets, WikiText-2 and Penn Treebank (PTB), in chunks of length 512. The LLMs employed in perplexity testing are LLaMA-2-7B (with the original 16-bit and quantized 4-bit weights) and StableLM-3B-4E1T (with 8-bit and 4-bit quantized weights).

LLMs using the original dot-product attention are considered the baseline for comparing the model quality of LLMs operating in accordance with embodiments of the present disclosure, as well as PCA-Attention-based LLMs. Principal Component Analysis (PCA) is a well-used and studied dimensionality reduction technique. By reducing the dimensionality of query and key embeddings via PCA, the efficiency of attention score computation can be improved. Embodiments of the present disclosure as well as PCA require codebook learning and projection learning, respectively. In each case, the key embeddings of the first 100 samples from the training set of WikiText-2 and PTB datasets are used for learning. This avoids the train-test overlap and ensures that the codebooks learned can generalize to unseen data. For the same model, the codebooks and projection are learned only once and used for different quantization schemes. For the original dot-product attention, the compression of the key cache from FP32 is varied to q4_0 and q8_0 (each float uses 4.5 and 8.5 bits respectively). For StableLM models, q4_0 and q8_0 key cache compression is not supported by the llama.cpp library, and is hence omitted. For embodiments of the present disclosure as well as PCA, all attention heads in the LLM are replaced with their attention variant.

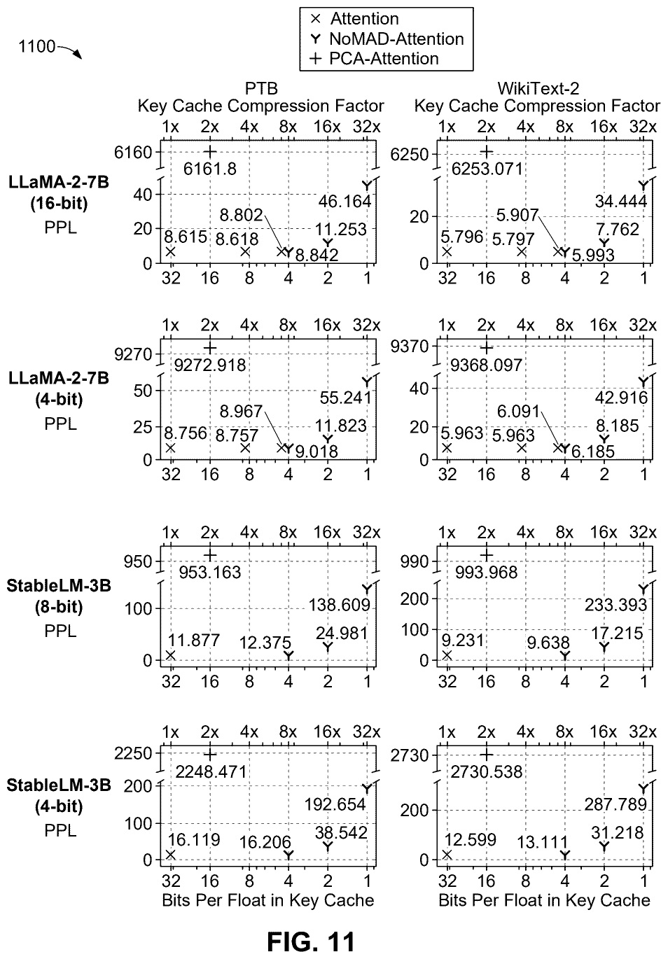

FIG. 11 depicts a plurality of perplexity values (1100) as a function of bits per float in the key cache in accordance with one or more embodiments. LLMs operating according to embodiments of the present disclosure maintain model quality with negligible degradation in perplexity compared to the original model at 8× key cache compression/4 bits per float in key/d_{sub}=1 (consistently less than a 4% increase). In contrast, the dimensionality-reduction-based method PCA fails to maintain model quality at 2 key cache compression. At 8 times key cache compression, or d_{sub}=1, LLMs operating according to embodiments of the present disclosure maintain model quality well compared to the original Attention-based LLMs, as demonstrated by the perplexity metric. Beyond 8 times key cache compression, LLMs operating according to embodiments of the present disclosure drop in quality with increasing compression factor. However, embodiments of the present disclosure are significantly better than PCA-Attention in maintaining model quality. The quality of attention drops catastrophically when dimensionality reduction is applied. This is likely because dimensionality reduction strategies use symmetric dot-product computations, while embodiments of the present disclosure use asymmetric dot-product computations.

Model efficiency is measured using CodeLlama-7B (with 16-bit and 4-bit weights), a variant of the Llama LLM that supports a long context length of 16384. Ten sequences of varying lengths, up to 16K, are sampled from the stack-overflow-questions dataset and are used as prompts to generate 4096 tokens. The baseline implementation is based on the llama.cpp implementation. The experiments are run with all available 28 CPU cores. For efficiency comparisons, the time to the first token (time to finish prompt processing), decoding time for each token, and decoded tokens per second are each reported.

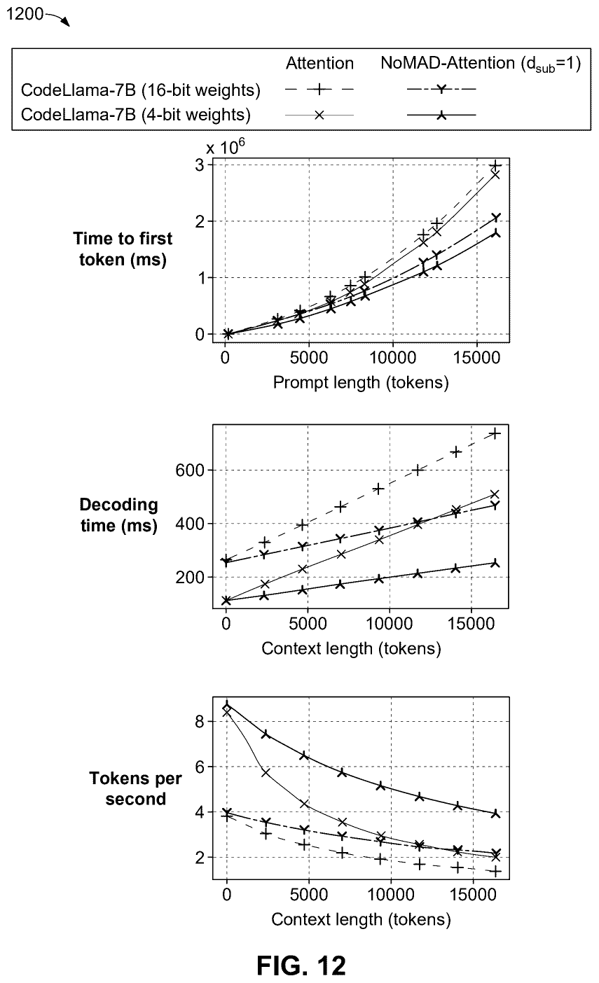

The experimental results of the model efficiency comparison are given in FIG. 12. In particular, FIG. 12 depicts a plurality of efficiency values (1200) in accordance with one or more embodiments. Since embodiments of the present disclosure maintain model quality well at 8 times key cache compression or d_{sub}=1, speedup is explored using this configuration. The results of embodiments of the present disclosure at d_{sub}=2 are included in the appendix. LLMs operating according to embodiments of the present disclosure achieve significant speedups over the original models. For example, CodeLlama-7B (4-bit weights) operating according to embodiments of the present disclosure achieves 2 times speedup over the original CodeLlama-7B (4-bit weights) at 16k sequence length.

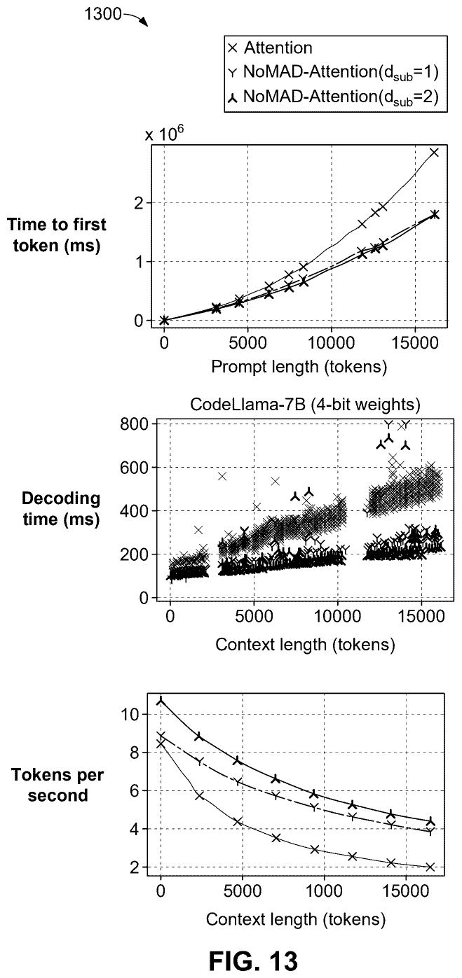

Additional results of the model efficiency comparison are depicted in FIG. 13. In particular, FIG. 13 depicts a plurality of efficiency values (1300) in accordance with one or more embodiments. The efficiency of Attention-based and CodeLLaMA-7B models operating according to embodiments of the present disclosure on prompt processing and decoding are shown. Concerning the time required to finish prompt processing, the original model with 4-bit quantized weights takes 2.8×10⁶ ms, while the CodeLlama-7B operating according to embodiments of the present disclosure only require approximately 1.8×10⁶ ms for models with both d_{sub}=1 and d_{sub}=2, achieving over a 1.5× increase at a 16k prompt length.

Regarding the decoding time for each token, the original model with 4-bit quantized weights takes 450-600 ms, while CodeLlama-7B operating according to embodiments of the present disclosure only requires approximately 220 and 200 ms for models with d_{sub}=1 and d_{sub}=2 respectively, achieving over a 2× increase at a 16k prompt length. In terms of throughput measured by tokens per second, at a context length of 16k, CodeLlama-7B operating according to embodiments of the present disclosure can achieve speeds of 4 and 2.2 tokens per second on models with 16-bit and 4-bit quantized weights, respectively. In contrast, the original model only manages 2 and 0.8 tokens per second, demonstrating more than a 2 increase at the 16k context length. The original model with 4-bit quantized weights only manages 2 tokens per second, while CodeLlama-7B operating according to embodiments of the present disclosure can achieve speeds of up to 4 and 4.2 tokens per second for models with d_{sub}=1 and d_{sub}=2 respectively, also achieving over a 2× increase at a 16k prompt length.

Overall, the CodeLlama-7B (4-bit quantized weights) operating according to embodiments of the present disclosure achieves a 2× speedup over the original CodeLlama-7B (4-bit quantized weights) at long prompt and context lengths (e.g., 16k).

The efficiency of attention score computation and key caching are compared for single-head attention (the ordinary approach), attention scores computed in accordance with embodiments of the present disclosure, and PQ-Attention to study the effectiveness of embodiments of the present disclosure. PQ-Attention quantizes keys into 8-bit codes in each sub-quantizer and performs asymmetric dot product computations. To match the key compression factor, PQ-Attention at d_{sub}=2 is used, while d_{sub}=1 is used to measure the performance of one or more embodiments of the present disclosure. In this measurement, 16k queries at a context length of 16k are performed and the latency of each attention in attention score computation and key caching is measured using a single thread.

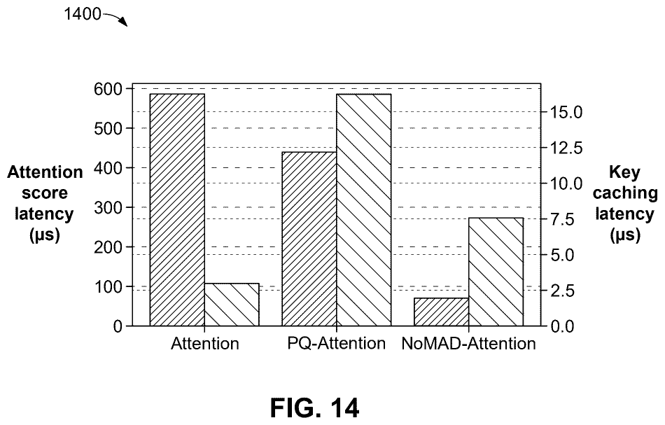

The results of the ablation study are given in FIG. 14. FIG. 14 depicts a bar chart of latency values (1400) in accordance with one or more embodiments. The latency per query of ordinary Attention, PQ-Attention (8-bit code, d_{sub}=2), and embodiments of the present disclosure (4-bit code, d_{sub}=1) in computing attention scores and key caching for 16k queries at 16k context length are compared. PQ-Attention yields limited speedup compared to ordinary Attention and incur the most overhead in key caching due to the large size of codebooks. Embodiments of the present disclosure significantly reduces the latency of attention score computations over ordinary Attention.

Despite replacing MADs with lookups, PQ-Attention yields limited speedup as compared to dot-product attention. By contrast, embodiments of the present disclosure achieve 8.3 times speedup over MAD-based attention. The key caching time of PQ-Attention is 2 times more than embodiments of the present disclosure, since finding the code for each sub-quantizer takes 256 distance computations as opposed to 16.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method, comprising:
obtaining, by a large language model in a computer, an input sequence of text comprising a plurality of elements of text;
converting, by the computer, each element in the plurality of elements of text into a token, resulting in a plurality of tokens;
transforming, by the computer, each token in the plurality of tokens into a query vector, key vector, and value vector, resulting in a plurality of query vectors, key vectors, and value vectors;
obtaining, by the computer, a plurality of quantized key vectors by applying product quantization to the plurality of key vectors; and
for each query vector:
compressing, by the computer, a lookup table into at least one single instruction multiple data (SIMD) register of a plurality of SIMD registers in a computer processor to produce a compressed lookup table, wherein the lookup table is based on the query vector and the plurality of quantized key vectors;
performing, by the computer, a parallel processing operation using a plurality of SIMD instructions and the lookup table in the SIMD register to determine a plurality of attention scores; and
generating, by the large language model, a predicted sequence of text based on the plurality of attention scores,
wherein the large language model determines the predicted sequence of text using the plurality of attention scores by accessing the compressed lookup tables in the at least one SIMD register.

2. The method of claim 1, wherein applying product quantization to the plurality of key vectors comprises:
dividing, by the computer, the plurality of key vectors into a plurality of sub-vectors;
performing, by the computer, clustering on a set of a plurality of training vectors selected from the plurality of sub-vectors resulting in a plurality of cluster centroids; and
for each sub-vector, using a sub-quantizer to:
quantize, by the computer, the sub-vector based on the nearest cluster centroid of the plurality of cluster centroids, resulting in a codebook, comprising plurality of codes, for each sub-quantizer;
wherein each code in the codebook represents a set of indices to the cluster centroids that are nearest to each sub-vector.

3. The method of claim 2, wherein each code in the codebook uses 8 bits of memory.

4. The method of claim 2, wherein the lookup table for each query vector includes a plurality of dot product values computed, by the computer, between the query vector and the plurality of sub-vectors using the codes in the codebook of each sub-quantizer.

5. The method of claim 4, wherein for each sub-quantizer, the dot product values between each query vector and cluster centroid in the codebook are dynamically compressed based on maximum and minimum dot product values.

6. The method of claim 4, wherein determining a plurality of attention scores comprises:
retrieving dot product values stored in the lookup table for each query vector using codes in the codebook of each sub-quantizer, and
accumulating the retrieved dot product values across the sub-quantizers.

7. The method of claim 2, wherein:
the large language model uses multiple attention heads; and
the codebook cluster centroids are learned through performing clustering separately on each attention head.

8. The method of claim 6, wherein compressing the lookup table into the SIMD register comprises dynamically quantizing the dot product values as 8-bit representations.

9. The method of claim 1, wherein the plurality of quantized key vectors are stored in a transposed block format.

10. The method of claim 1, wherein the plurality of SIMD instructions include a shuffle command and an add command.

11. A non-transitory computer-readable medium storing instructions that, when executed by a central processing unit, cause the central processing unit (CPU) to perform a method comprising:
obtaining an input sequence of text comprising a plurality of elements of text;
converting each element in the plurality of elements of text into a token, resulting in a plurality of tokens;
transforming each token in the plurality of tokens into a query vector, key vector, and value vector, resulting in a plurality of query vectors, key vectors, and value vectors;
obtaining a plurality of quantized key vectors by applying product quantization to the plurality of key vectors; and
for each query vector:
compressing a lookup table into at least one single instruction multiple data (SIMD) register of a plurality of SIMD registers in the CPU to produce a compressed lookup table, wherein the lookup table is based on the query vector and the plurality of quantized key vectors;
performing a parallel processing operation using a plurality of SIMD instructions and the lookup table in the SIMD register to determine a plurality of attention scores; and
generating a predicted sequence of text based on the plurality of attention scores,
wherein the predicted sequence of text is determined using the plurality of attention scores by accessing the compressed lookup tables in the at least one SIMD register.

12. The non-transitory computer-readable medium of claim 11, wherein applying product quantization to the plurality of key vectors comprises:
dividing, by the computer, the plurality of key vectors into a plurality of sub-vectors;
performing, by the computer, clustering on a set of a plurality of training vectors selected from the plurality of sub-vectors resulting in a plurality of cluster centroids; and
for each sub-vector, using a sub-quantizer to:
quantize, by the computer, the sub-vector based on the nearest cluster centroid of the plurality of cluster centroids, resulting in a codebook, comprising plurality of codes, for each sub-quantizer;
wherein each code in the codebook represents a set of indices to the cluster centroids that are nearest to each sub-vector.

13. The non-transitory computer-readable medium of claim 12, wherein each code in the codebook uses 8 bits of memory.

14. The non-transitory computer-readable medium of claim 12, wherein the lookup table for each query vector includes a plurality of dot product values computed, by the computer, between the query vector and the plurality of sub-vectors using the codes in the codebook of each sub-quantizer.

15. The non-transitory computer-readable medium of claim 14, wherein for each sub-quantizer, the dot product values between each query vector and cluster centroid in the codebook are dynamically compressed based on maximum and minimum dot product values.

16. The non-transitory computer-readable medium of claim 14, wherein determining a plurality of attention scores comprises:
retrieving dot product values stored in the lookup table for each query vector using codes in the codebook of each sub-quantizer, and
accumulating the retrieved dot product values across the sub-quantizers.

17. The non-transitory computer-readable medium of claim 12, wherein:
the large language model uses multiple attention heads; and
the codebook cluster centroids are learned through performing clustering separately on each attention head.

18. The non-transitory computer-readable medium of claim 16, wherein compressing the lookup table into the SIMD register comprises dynamically quantizing the dot product values as 8-bit representations.

19. The non-transitory computer-readable medium of claim 11, wherein the plurality of quantized key vectors are stored in a transposed block format.

20. The non-transitory computer-readable medium of claim 11, wherein the plurality of SIMD instructions include a shuffle command and an add command.
